(19) United States
(12) Patent Application Publication
(10) Pub. No.: US 2012/0099299 A1
(43) Pub. Date: Apr. 26, 2012

(54) APPAREL WITH LIGHT-VIEWING PORTION

(75) Inventor: Anya Gorson, Portland, OR (US)

(73) Assignee: COLUMBIA SPORTSWEAR NORTH AMERICA, INC., Portland, OR (US)

(21) Appl. No.: 13/278,076

(22) Filed: Oct. 20, 2011

Related U.S. Application Data
(60) Provisional application No. 61/405,087, filed on Oct. 20, 2010.

(51) Int. Cl. F21V 21/08; B23P 11/00

(52) U.S. Cl. 362/103; 29/428

(57) ABSTRACT

Embodiments of apparatus, methods and systems are described herein for providing apparel with a light-viewing portion. In various embodiments, apparel, including outerwear such as a jacket, may include a power supply; a light source coupled to the power supply; and an external textile layer with a light-viewing portion adjacent the light source, the light-viewing portion including one or more apertures through which light from the light source passes. In various embodiments, a heat source and controls for causing the heat source to provide various temperatures may also be provided. Other embodiments may be described and/or claimed.

### CROSS REFERENCE TO RELATED APPLICATIONS

This application claims priority under 35 U.S.C. §119(e) to U.S. Provisional Patent Application No. 61/405,087 entitled “APPAREL ILLUMINATION PORT APPARATUS AND METHOD,” filed Oct. 20, 2010, the disclosure of which is incorporated herein by reference.

### TECHNICAL FIELD

Embodiments of the present disclosure relate generally to apparel, and in particular to providing a light-viewing portion on apparel to permit external viewing of an internal light source.

### BACKGROUND

Apparel, particularly outerwear such as winter jackets and snow pants, may be a source of warmth in cold conditions. Some cold climate outerwear utilizes passive warming systems, such as insulation and/or a variety of materials and cuts. More recently, there is a movement toward including heat sources in outerwear. These are sometimes referred to as “active heating systems.” An active heating system may include a power supply, one or more heating elements strategically positioned on the outerwear, and controls to activate, control and/or deactivate the heating system. As winter outerwear can be bulky, it may be difficult to activate and deactivate the active heating system as well as readily identify if the system is active or inactive.

### BRIEF DESCRIPTION OF THE DRAWINGS

Embodiments will be readily understood by the following detailed description in conjunction with the accompanying drawings. Embodiments herein are illustrated by way of example and not by way of limitation in the figures of the accompanying drawings.

FIG. 1 illustrates a front view of a portion of an example jacket with a light-viewing portion, in accordance with various embodiments;

FIG. 2 is an enlarged view of a light-viewing portion, in accordance with various embodiments;

FIG. 3 illustrates a cross section of a portion of apparel illustrating an example of a light-viewing portion aligned with a protective layer, a light source and controls, in accordance with various embodiments;

FIG. 4 is a schematic depiction of a heating system that may be incorporated into outerwear such as a jacket or pants, in accordance with various embodiments; and

FIG. 5 is a flowchart depicting an example method of manufacturing outerwear with a light-viewing portion, in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present disclosure; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present disclosure.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

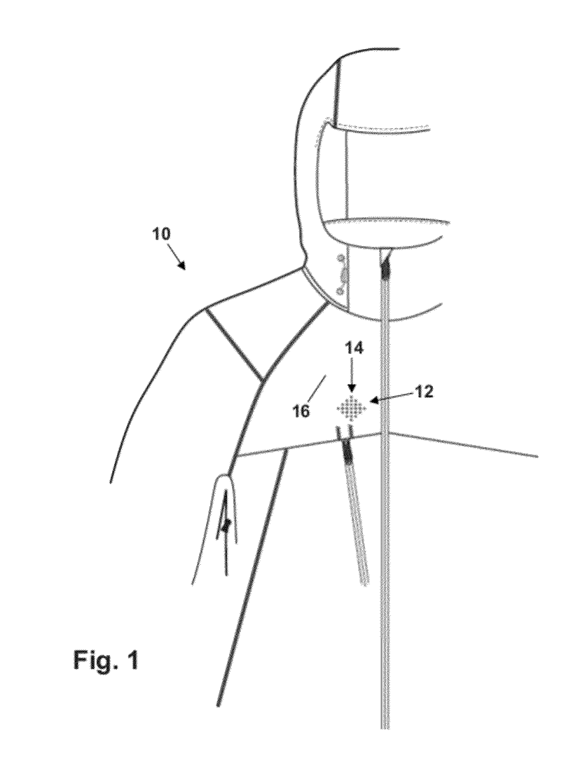

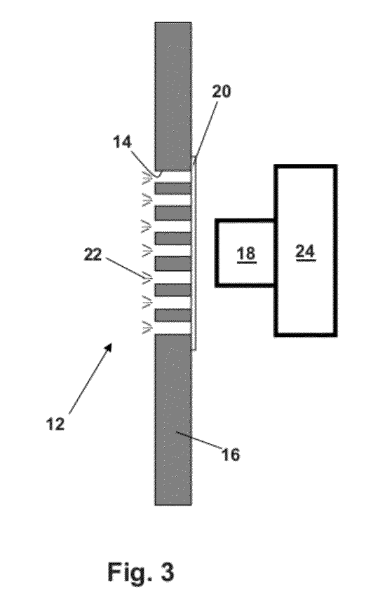

Referring now to FIG. 1, apparel, particularly outerwear such as a jacket 10, may include a light-viewing portion 12 on an external textile layer 16 of jacket 10. A light-viewing portion 12 may be disposed on the jacket 10 in a desired location, which in FIG. 1 is the upper right chest region. In various embodiments, however, light-viewing portions may be disposed anywhere on the outerwear. A light source (see FIG. 3) may be disposed generally behind the light-viewing portion 12 such that light emitted from the light source may be viewed through the light-viewing portion 12.

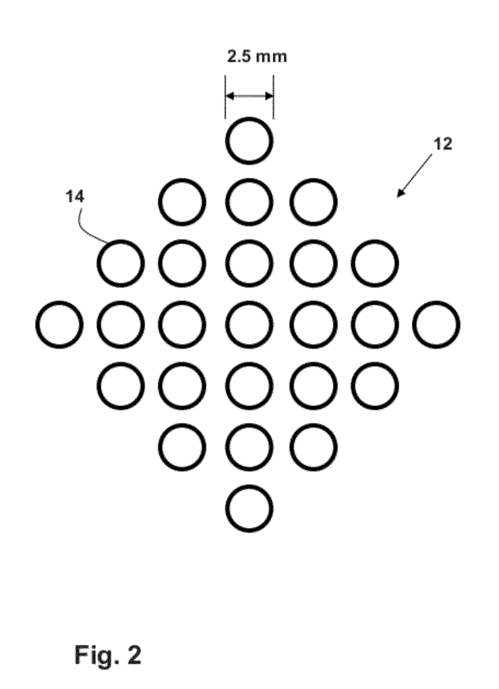

As seen best in FIG. 2, light-viewing portion 12 may include a plurality of apertures 14 in at least the external layer 16 of the jacket 10. Apertures 14 may be positioned on external layer 16 to generally overlie the light source. The shape of light-viewing portion 12 may be formed of, for example, a pattern of laser cut holes in the fabric of external layer 16. In various embodiments, the size and pattern may be selected so as to provide enough openings/passages and/or area to allow light to pass through from a light source, but not so much so as to create a distraction.

In some embodiments, apertures 14 may be arranged in a pattern to form an overall shape. The pattern may be positioned on outerwear such as jacket 10 in a readily viewable location, such as the upper chest region as shown in FIG. 1. In some embodiments, such as those seen in FIGS. 1, 2 and 4, the pattern may form a diamond. For example, FIG. 2 is a close-up view of an example light-viewing portion 12. A matrix of apertures 14 is arranged in a cross-pattern configuration of seven apertures 14 across the center and seven apertures 14 from top to bottom, also passing through the center. A variety of other patterns of apertures may be used to form a variety of other shapes, such as squares, circles, designs, logos and/or names.

In various embodiments, individual apertures 14 making up the pattern may also be sized and/or shaped so as to allow a desired amount of light to be visible from each aperture 14. For example, in some embodiments, apertures 14 may be between 1 and 4 millimeters in diameter or width. In other embodiments, such as that shown in FIG. 2, apertures 14 are approximately 2.5 millimeters in diameter. In various embodiments, the individual apertures may also have other shapes, such as squares, diamonds, triangles, and so forth. Although the figures herein show apertures 14 having the same size and shape, individual apertures may be sized and/or shaped differently as desired.

FIG. 3 is a cross-sectional view of example apparel that shows a light source 18, in accordance with various embodiments. A protective layer 20 may be disposed between light source 18 and external layer 16 of the outerwear. In various embodiments, protective layer 20 may be a light-permeable membrane (e.g., transparent sheet of plastic) that may be secured to an inner surface of external layer 16 so that it overlays light-viewing portion 12. Protective layer 20 may permit light 22 emitted from light source 18 to pass through apertures 14 of light-viewing portion 12, and may also prevent moisture and/or other elements from passing through.

In other embodiments, protective layer 20 may be coupled to an exterior surface of external layer 16, disposed about (covering) light-viewing portion 12. In various embodiments, protective layer 20 may be opaque or otherwise configured to allow passage of light. In some embodiments, protective layer 20 may be waterproof. In various embodiments, protective layer 20 may prevent or impede the passage of moisture but permit the passage of air (e.g., may be “breathable”).

In other embodiments, protective layer 20 may be absent.

In various embodiments, controls 24 may be provided to activate, control and/or deactivate light source 18. In various embodiments, such as that shown in FIG. 3, light source 18 may be coupled to controls 24. As will be discussed below, controls 24 may be part of a heating system, and may be manipulated by a wearer to activate and/or control the heating system to cause it to emit various temperatures, which in turn may cause light source 18 to emit various light outputs.

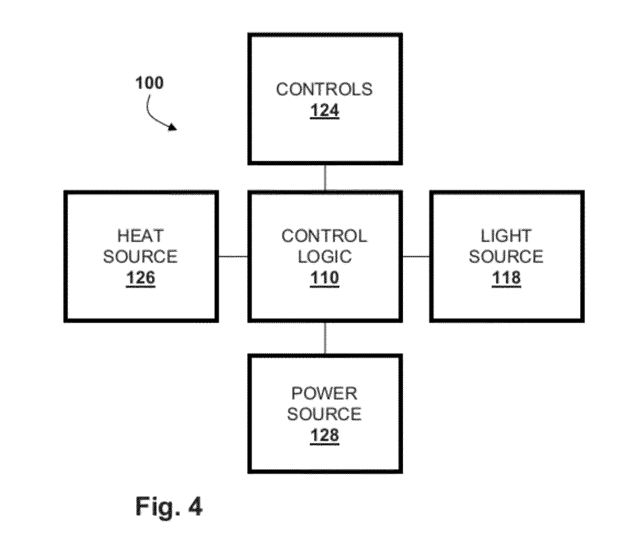

An example heating system 100 is depicted schematically in FIG. 4. Heating system 100 may include control logic 110, a light source 118, controls 124, a heat source 126, and a power source 128. Light source 118 may be configured to emit light depending on various states of operation of components such as heat source 126. Control logic 110 may be operated using controls 124 to cause heat source 126 and/or light source 118 to provide output. Controls 124 may include various types of switches and/or actuators for providing input to control logic 110. In some embodiments, controls 124 may enable adjustment between a range of temperatures provided by heat source 126. In some embodiments, a particular color of light emitted from light source 118 may depend in whole or in part on a selected temperature. In other embodiments, controls 124 may enable individual adjustment of both a temperature provided by heat source 126 and a color of light emitted from light source 118.

For example, in various embodiments, light source 118 may include a light emitting diode (“LED”) that emits a different color depending on whether the heating system 100 is activated and at what temperature heating system 100 is set. In some embodiments, the LED may emit no light to indicate that heating system 100 is deactivated, a green light to indicate that heating system 100 is at a low temperature setting, a yellow light to indicate that heating system 100 is at a medium temperature setting, and/or a red light to indicate that heating system 100 is at a high temperature setting. A variety of light colors may be used to signify various states of operation of heat source 126, such as temperature output, whether heat source 126 is warming up/cooling down, whether a battery included in power source 128 is running low on stored energy, which individual heating elements of heat source 126 are active, and so forth.

Power supply 128 may provide power to heating system 110. Power supply 128 may include a variety of power sources, such as rechargeable and non-rechargeable batteries. In some embodiments where power supply 128 includes a rechargeable battery, energy collection mechanisms (not shown) such as solar panels may be provided to collect energy (e.g., from the sun) to recharge the battery.

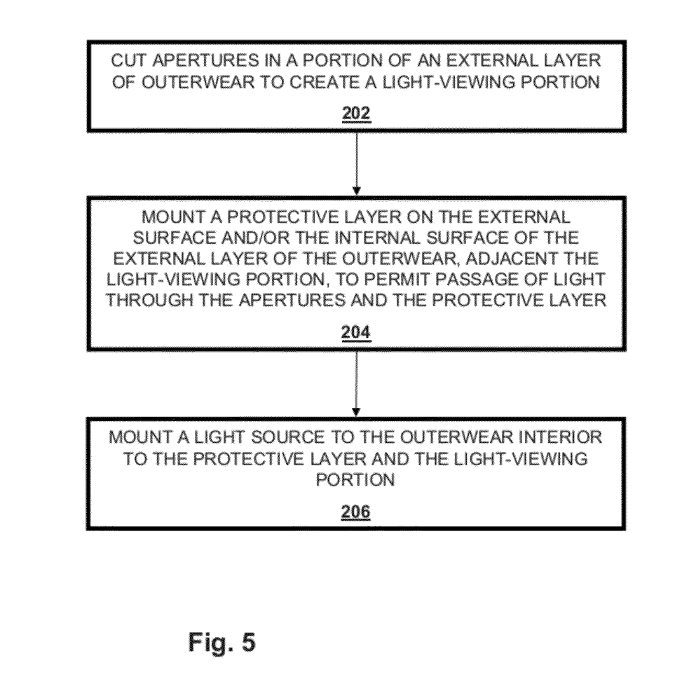

Various techniques may be implemented to manufacture outerwear having light-viewing portions. A flowchart of an example method is shown in FIG. 5. While the operations appear in a particular order, this is not meant to be limiting, as one or more operations may be switched, added or omitted. At 202, apertures (e.g. 14) may be cut into a portion of an external layer (e.g., 16) of outwear to create a light-viewing portion (e.g., 12). In some embodiments, the apertures may be cut with a laser. At 204, a protective layer (e.g., 20) may be mounted on one or more of the external or internal surface of the external layer adjacent the light-viewing portion, to permit passage of light through the apertures. At 206, a light source (e.g., 18, 118) may be mounted to the outerwear interior to the protective layer and the light-viewing portion.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments herein may be implemented in a very wide variety of ways. This application is intended to cover any adaptations or variations of the embodiments discussed herein. Therefore, it is manifestly intended that embodiments in accordance with the present disclosure be limited only by the claims and the equivalents thereof.

What is claimed is:

1. Apparel comprising:
a power supply;
a light source coupled to the power supply; and
an external textile layer with a light-viewing portion adjacent the light source, the light-viewing portion including one or more apertures through which light from the light source is configured to pass.

2. The apparel of claim 1, further comprising a protective layer disposed adjacent to the light-viewing portion.

3. The apparel of claim 2, wherein the protective layer is disposed on an exterior surface of the external textile layer adjacent to the light-viewing portion.

4. The apparel of claim 2, wherein the protective layer is disposed on an interior surface of the external textile layer adjacent to the light-viewing portion.

5. The apparel of claim 2, wherein the protective layer is a light-permeable membrane that permits passage of light from the light source through the light-permeable membrane and through at least one of the one or more apertures.

6. The apparel of claim 5, wherein the light-permeable membrane is transparent or translucent.

7. The apparel of claim 5, wherein the light-permeable membrane is waterproof.

8. The apparel of claim 5, wherein the light-permeable membrane permits passage of air.

9. The apparel of claim 1, further comprising controls and control logic coupled to the power source, wherein the controls are used to operate the control logic to selectively emit light from the light source.

10. The apparel of claim 9, wherein the light source is coupled to the controls.

11. The apparel of claim 1, further comprising a heat source coupled to the power source for providing heat to a wearer of the apparel, wherein the light source emits light when the heat source is active.

12. The apparel of claim 11, wherein the light source emits a plurality of colors corresponding to states of operation of the heat source.

13. The apparel of claim 12, wherein the states of operation include a plurality of temperatures.

14. A jacket comprising:
an external layer including a pattern of apertures; and
a heating system comprising a heat source and a light source adjacent the pattern of apertures, the light source configured to emit light through the pattern of apertures when the heating system is active.

15. The jacket of claim 14, wherein the one or more apertures are between 1 and 4 millimeters in diameter.

16. The jacket of claim 15, wherein the one or more apertures are approximately 2.5 millimeters in diameter.

17. A method of assembling outerwear, comprising:
cutting one or more apertures in a portion of an external layer of the outerwear to create a light-viewing portion;
mounting a protective layer on a surface of the external layer, adjacent the light-viewing portion, to permit passage of light through the protective layer and through at least one of the one or more apertures of the light viewing portion; and
mounting a light source to the outerwear interior to the protective layer and the light-viewing portion.
